(19) United States
(12) Patent Application Publication
(10) Pub. No.: US 2023/0074598 A1
(43) Pub. Date: Mar. 9, 2023

(54) BATTERY, BATTERY PACK, AND AUTOMOBILE

(71) Applicant: BYD COMPANY LIMITED, Shenzhen (CN)

(72) Inventors: Shichao HU, Shenzhen (CN); Yimiao JIANG, Shenzhen (CN); Mingming ZHANG, Shenzhen (CN)

(21) Appl. No.: 17/988,161

(22) Filed: Nov. 16, 2022

Related U.S. Application Data
(63) Continuation of application No. PCT/CN2021/089032, filed on Apr. 22, 2021.

(30) Foreign Application Priority Data
May 18, 2020 (CN) 202020848060.X

(51) Int. Cl. H01M 50/477; H01M 50/102; H01M 50/497; H01M 50/51; H01M 10/04

(52) U.S. Cl. CPC H01M 50/477; H01M 50/102; H01M 50/497; H01M 50/51; H01M 10/049

(57) ABSTRACT

A battery includes a housing and multiple electrode core assemblies disposed in the housing. Two adjacent electrode core assemblies are connected in series, each of the electrode core assemblies includes an encapsulation film and one electrode core, and the one electrode core is disposed in an accommodating cavity formed by the encapsulation film. Each of the electrode core assemblies includes a first electrode and a second electrode protruding out of the encapsulation film for leading out a current, a first electrode of a first electrode core assembly is connected to a second electrode of the a second electrode core assembly of the two adjacent electrode core assemblies, a gap between the two adjacent electrode core assemblies is filled with an insulating material to form an insulating spacer between the two adjacent electrode core assemblies, and a connection part of the two adjacent electrode core assemblies is arranged in the insulating spacer.

### CROSS-REFERENCE TO RELATED APPLICATION

This application is a continuation application of International Patent Application No. PCT/CN2021/089032 filed with the China National Intellectual Property Administration (CNIPA) on Apr. 22, 2021, which is based on and claims priority to and benefits of Chinese Patent Application No. 202020848060.X filed on May 18, 2020. The entire content of all of the above-referenced applications is incorporated herein by reference.

### FIELD

The present disclosure relates to the field of batteries, and more specifically, to a battery, a battery pack, and an automobile.

### BACKGROUND

In the related art, in order to increase the battery capacity, multiple electrode cores are connected in series in the housing of the battery, so that the connection parts between the electrode cores are prone to be twisted or broken during the use of the battery. In addition, under the vibration or bumpy conditions, the multiple electrode cores are prone to moving in the housing, and generate displacement therebetween, which will damage the electrode cores. For example, a current collector is damaged, a separator is wrinkled, and an active material layer on the electrode peels off, which will lead to a poor stability of the battery, causing safety problems.

### SUMMARY

The present disclosure resolves at least one of the technical problems in the prior art. Therefore, the present disclosure provides a battery in which electrode core assemblies are connected more reliably.

In a first aspect, a battery is provided, including a housing and multiple electrode core assemblies disposed in the housing. Two adjacent electrode core assemblies of the plurality of electrode core assemblies are connected in series, each of the electrode core assemblies includes an encapsulation film and at least one electrode core, and the at least one electrode core is disposed in an accommodating cavity formed by the encapsulation film. Each of the electrode core assemblies includes a first electrode and a second electrode for leading out a current, the first electrode and the second electrode protrude out of the encapsulation film, a first electrode of a first electrode core assembly of the two adjacent electrode core assemblies is connected to a second electrode of the a second electrode core assembly of the two adjacent electrode core assemblies, a gap between the two adjacent electrode core assemblies is filled with an insulating material to form an insulating spacer between the two adjacent electrode core assemblies, and a connection part of the two adjacent electrode core assemblies is arranged in the insulating spacer.

In an embodiment, the insulating spacer is formed between two adjacent electrode core assemblies, and the connection part of the two adjacent electrode core assemblies is arranged in the insulating spacer. In this way, the insulating spacer can be well utilized to fix the electrode core assemblies, so as to prevent the relative movement between the electrode core assemblies, to maintain the reliable connection between the electrode core assemblies, and to increase the strength of the connection part, thereby preventing the connection part between the two adjacent electrode core assemblies from being twisted or broken during the use of the battery, and improving the connection stability between the electrode core assemblies.

In a second aspect, a battery pack is provided, including the above-mentioned battery.

In a third aspect, an automobile is provided, including the above-mentioned battery pack.

Additional aspects and advantages of the present disclosure will be given in the following description, some of which will become apparent from the following description or may be learned from practices of the present disclosure.

### BRIEF DESCRIPTION OF THE DRAWINGS

The foregoing and/or additional aspects and advantages of the present disclosure will become apparent and comprehensible in the embodiment description made with reference to the following accompanying leading outs, where:

FIG. 1 is a schematic structural diagram of a battery according to an embodiment of the present disclosure;

FIG. 2 is a schematic structural diagram of a battery with a housing being removed according to a first embodiment of the present disclosure;

FIG. 3 is a schematic structural diagram of an electrode core assembly according to an embodiment of the present disclosure;

FIG. 4 is a schematic cross-section view of FIG. 3 taken along line IV-IV;

FIG. 5 is a schematic cross-section view of FIG. 1 taken along line V-V in the first embodiment of the present disclosure;

FIG. 6 is a schematic cross-section view of FIG. 5 in another embodiment;

FIG. 7 is a schematic cross-section view of FIG. 5 in still another embodiment;

FIG. 8 is a schematic cross-section view of FIG. 1 taken along line VIII-VIII in a second embodiment of the present disclosure;

FIG. 9 is a schematic cross-section view of FIG. 8 in a third embodiment;

FIG. 10 is an exploded view of a battery with a housing being removed according to a third embodiment of the present disclosure;

FIG. 11 is a schematic structural diagram of a battery pack according to an embodiment of the present disclosure; and

FIG. 12 is a schematic diagram of an automobile according to an embodiment of the present disclosure.

### DETAILED DESCRIPTION

Embodiments of the present disclosure are described in detail below, and examples of the embodiments are shown in accompanying leading outs, where the same or similar elements or the elements having same or similar functions are denoted by the same or similar reference numerals throughout the description. The embodiments described below with reference to the accompanying leading outs are exemplary and explain the present disclosure and cannot be construed as a limitation to the present disclosure.

In the description of the present disclosure, it should be understood that orientation or position relationships indicated by the terms such as “center”, “upper”, “lower”, “front”, “rear”, “left”, “right”, “vertical”, “horizontal”, “top”, “bottom”, “inside”, and “outside” are based on orientation or position relationships shown in the accompanying leading outs, and are used only for ease and brevity of illustration and description of the present disclosure, rather than indicating or implying that the mentioned apparatus or component must have a particular orientation or must be constructed and operated in a particular orientation. Therefore, such terms should not be construed as limiting of the present disclosure.

It should be noted that, the terms “first” and “second” are used for descriptive purposes only and should not be construed as indicating or implying relative importance or implicitly indicating the number of technical features indicated. Therefore, features defining “first” and “second” may explicitly or implicitly include one or more such features. Further, in the description of the present disclosure, unless otherwise stated, “multiple” means two or more than two.

The present disclosure provides a battery 100, including a housing 10 and multiple electrode core assemblies 20 encapsulated or disposed in the housing 10. Every two adjacent electrode core assemblies 20 are connected in series. The electrode core assembly 20 includes an encapsulation film 201 and at least one electrode core 202, and the electrode core 202 is arranged in an accommodating cavity formed by the encapsulation film 201. The electrode core assembly 20 includes a first electrode 21 and a second electrode 22 for leading out a current. The first electrode 21 and the second electrode 22 protrude out of the encapsulation film 201. The first electrode 21 of one of the two adjacent electrode core assemblies 20 is electrically connected to the second electrode 22 of the other electrode core assembly. A gap between the two adjacent electrode core assemblies 20 is filled with an insulating material to form an insulating spacer 30 between the two adjacent electrode core assemblies 20. A connection part 306 of the two adjacent electrode core assemblies 20 is arranged in the insulating spacer 30.

Compared with the prior art, the beneficial effects of the present disclosure are as follows.

In the present disclosure, the insulating spacer 30 is arranged between every two adjacent electrode core assemblies 20, and the connection part 306 of the two electrode core assemblies 20 is arranged in the insulating spacer 30. In this way, the insulating spacer 30 can be well utilized to fix the electrode core assemblies 20, to prevent the relative movement between the electrode core assemblies 20, to maintain the reliable connection between the electrode core assemblies 20, and to increase the strength of the connection part 306, thereby preventing the connection part 306 between the two adjacent electrode core assemblies 20 from being twisted or broken during the use of the battery 100, and improving the connection stability between the electrode core assemblies 20.

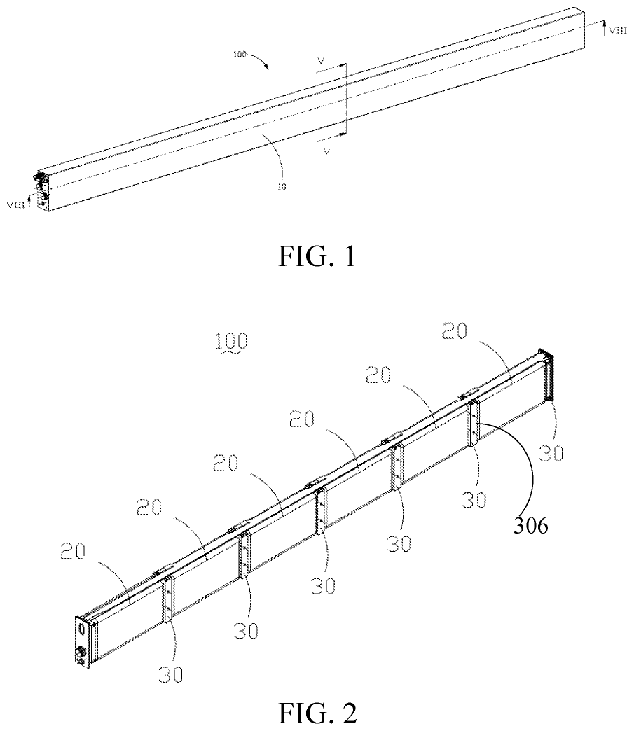

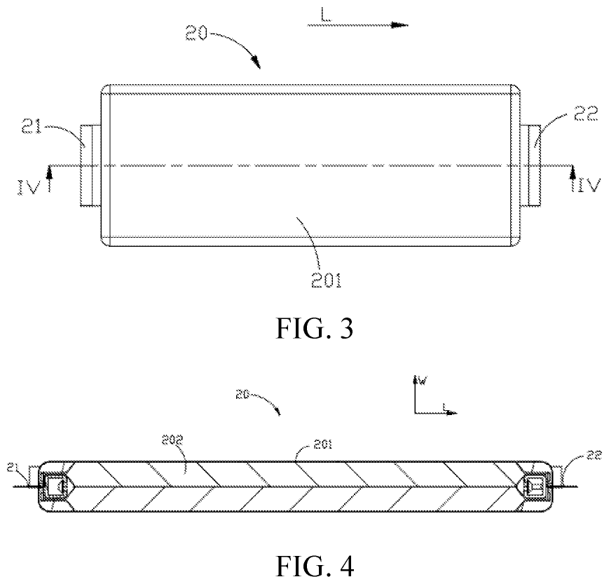

Referring to FIG. 1 and FIG. 2, a battery 100 includes a housing 10 and multiple electrode core assemblies 20 encapsulated or disposed in the housing 10, and every two adjacent electrode core assemblies 20 are connected in series. Referring to FIG. 3 and FIG. 4, the electrode core assembly 20 includes an encapsulation film 201 and at least one electrode core 202, and the electrode core 202 is arranged in an accommodating cavity formed by the encapsulation film 201. In some embodiments of the present disclosure, the encapsulation film 201 is an aluminum-plastic composite film or a polymer material composite film. The electrode core assembly 20 includes a first electrode 21 and a second electrode 22 for leading out a current. One of the first electrode 21 and the second electrode 22 is a positive electrode, and the other one of the first electrode 21 and the second electrode 22 is a negative electrode. The first electrode 21 and the second electrode 22 protrude out of the encapsulation film 201. The first electrode 21 of one of the two adjacent electrode core assemblies 20 is electrically connected to the second electrode 22 of the other electrode core assembly. A gap between the two adjacent electrode core assemblies 20 is filled with an insulating material to form an insulating spacer 30 between the two adjacent electrode core assemblies 20. A connection part 306 of the two adjacent electrode core assemblies 20 is arranged in the insulating spacer 30.

In some embodiments of the present disclosure, a length of the battery 100 extends along a first direction L, a thickness of the electrode core assembly 20 extends along a second direction W. The second direction W and the first direction L are perpendicular to each other. A length of the electrode core assembly 20 extends along the first direction L, and the multiple electrode core assemblies 20 are arranged along the first direction L. In addition, the first electrode 21 and the second electrode 22 of the electrode core assembly 20 are arranged at two opposite ends of the electrode core assembly 20 along the first direction L. Besides, the two electrode core assemblies 20 that are connected in series are adjacent to each other, that is, in the embodiments of the present disclosure, every two adjacent electrode core assemblies 20 are connected in series. Therefore, the multiple electrode core assemblies 20 are arranged in an end-to-end manner. In this manner, it is easy to realize the series connection between every two adjacent electrode core assemblies 20, and the connecting structure is simple. In addition, in this manner, it is easy to manufacture the battery 100 with a larger length. Thereby, when the battery 100 is to be mounted into a casing of the battery pack 200, there is no need to provide support structures such as cross beams and longitudinal beams. Instead, by using the housing 10 of the battery 100 as the support, the battery 100 is directly mounted on the casing of the battery pack 200, which can save the internal space of the battery pack 200, improve the volume utilization of the battery pack 200, increase the energy density of the battery pack 200, and reduce the weight of the battery pack 200.

In some embodiments of the present disclosure, the multiple electrode core assemblies 20 may form two electrode core strings. That is, the battery 100 may contain two electrode core strings, which may be connected in series. For example, the two electrode core strings may be connected in a U shape, that is, the corresponding electrodes of the two electrode core strings at the same end in a first direction L are connected in series, and the corresponding electrodes of the two electrode core strings at the other end in the first direction L are respectively positive electrodes and negative electrodes of the battery.

Each electrode core string has multiple electrode core assemblies 20, the two electrode core strings are arranged along a second direction W, and the multiple electrode core assemblies 20 in each electrode core string are arranged along the first direction L. In addition, the first electrode 21 and the second electrode 22 of the electrode core assembly 20 are arranged at two opposite ends of the electrode core assembly 20 along the first direction L, and the two electrode core assemblies 20 that are connected in series are adjacent to each other. That is, in the embodiments of the present disclosure, for the multiple electrode core assemblies 20 in each electrode core string, every two adjacent electrode core assemblies 20 are connected in series. Therefore, the multiple electrode core assemblies 20 in each electrode core string are arranged in an end-to-end manner. In this manner, it is easy to realize series connection between every two adjacent electrode core assemblies 20, and the connecting structure is simple.

In other embodiments, the battery 100 may be provided with only one electrode core string. That is, all the electrode core assemblies 20 in the battery 100 are sequentially arranged along the first direction L, and all the electrode core assemblies 20 are connected in series to form one electrode core string.

When the multiple electrode core assemblies 20 are connected in series, the connection parts 306 between the electrode core assemblies 20 become the vulnerable parts of the whole battery 100, and are prone to be twisted and broken during the use of the battery 100, resulting in connection failure. Moreover, the multiple electrode core assemblies 20 are connected in series in the battery 100, which increases the risk of the battery moving in the first direction L. Therefore, in the present disclosure, the insulating spacer 30 formed by filling the gap between two adjacent electrode core assemblies 20 with the insulating material is arranged between the two electrode core assemblies 20 connected in series. The insulating spacer 30 can adhere to the two adjacent electrode core assemblies 20, so that the connection between the insulating spacer 30 and the two electrode core assemblies 20 adjacent thereto is more stable and reliable. Moreover, the connection part 306 of the two electrode core assemblies 20 connected in series is arranged in the insulating spacer 30, which can increase the strength of the connection part between the first electrode 21 and the second electrode 22. The insulating spacer 30 can be utilized to better fix the electrode core assemblies 20, to prevent the movement between the electrode core assemblies 20, to maintain the effective connection between the electrode core assemblies 20, and to increase the strength of the connection part, thereby preventing the connection part between the electrode core assemblies 20 from being twisted or broken during the use of the battery, and improving the connection stability between the electrode core assemblies 20.

In some embodiments of the present disclosure, the two electrode core assemblies 20 that are connected in series are adjacent to each other, and the insulating spacer 30 is arranged between the two adjacent electrode core assemblies 20.

Thereby, the insulating spacer 30 is arranged between every two adjacent electrode core assemblies 20. The insulating spacer 30 can separate two adjacent electrode core assemblies 20, and the insulating spacer 30 and the housing 10 are positioned relative to each other, which can further prevent the electrode core assemblies 20 from moving along its first direction L.

In some embodiments of the present disclosure, when the battery 100 contains two electrode core strings, on each side of the insulating spacer 30 along the first direction L, two electrode core assemblies 20 are arranged, so that the number of the electrode core assemblies 20 can be increased, thereby increasing the electric capacity of the battery 100.

In some other embodiments of the present disclosure, only one electrode core assembly 20 is arranged in the second direction W, and the multiple electrode core assemblies 20 all extend along the first direction L. That is, on each side of the insulating spacer 30 along the first direction L, only one electrode core assembly 20 is arranged. This situation may be understood as only one electrode core string being arranged in the battery 100.

In one embodiment of the present disclosure, the housing 10 is a metal housing, for example, an aluminum housing. Of course, other metals may also be selected as required. Thereby, the housing 10 has sufficient strength to prevent it from being damaged or deformed, thereby improving the safety of the battery 100.

In some embodiments of the present disclosure, the encapsulation film 201 is an aluminum-plastic composite film or a polymer material composite film. The first electrode 21 and the second electrode 22 of the electrode core assembly 20 protrude out of the encapsulation film 201. That is, in the embodiments of the present disclosure, the insulating spacer 30 is arranged outside the encapsulation film 201. The connection reliability between the electrode core assemblies 20 is improved by arranging the insulating spacer 30 outside the encapsulation film.

In some embodiments of the present disclosure, the electrode core mentioned may be understood as an electrode core commonly used in the field of power batteries, and the electrode core and the electrode core assembly 20 are components inside the housing 10 of the battery 100, and cannot be understood as the battery itself. The electrode core may be an electrode core formed by winding, and the electrode core generally refers to a component that is not completely sealed. Thus, the battery 100 mentioned in the present disclosure cannot be simply understood as a battery module or a battery pack for inclusion of multiple electrode cores. In the present disclosure, the electrode core assembly 20 may include one single electrode core. The electrode core assembly may also include multiple electrode cores, and the multiple electrode cores are connected in parallel to form the electrode core assembly 20.

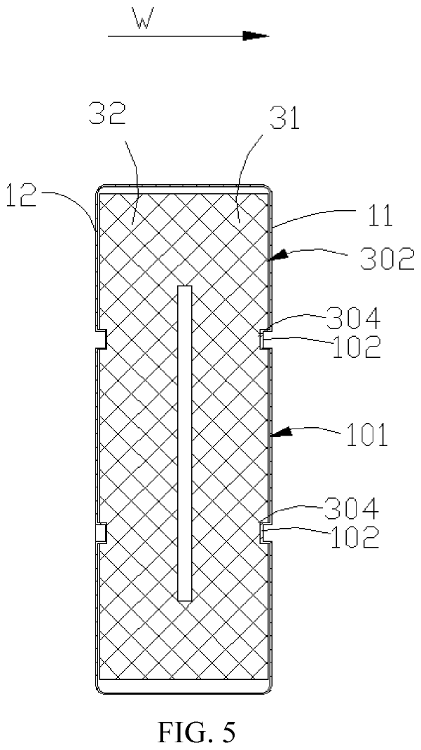

Referring to FIG. 5, in a first embodiment of the present disclosure, the spacer 30 includes an outer peripheral surface 302 facing an inner surface of the housing 10, and at least one first positioning portion 304 is formed on the outer peripheral surface 302 of the spacer 30. Second positioning portions 102 corresponding to the first positioning portions 304 one by one are formed on the inner surface 101 of the housing 10. The first positioning portion 304 is coupled with the corresponding second positioning portion 102 to fix the spacer 30 to the housing 10. For example, the first positioning portion 304 may be coupled or mated with the corresponding second positioning portion 102 to fix the spacer 30 to the housing 10.

Thereby, the first positioning portion 304 of the spacer 30 and the second positioning portion 102 on the housing 10 are coupled with each other to fix the spacer 30 to the housing 10, which can further prevent the relative movement between the electrode core assemblies 20, thereby improving the effect of preventing movement.

In some embodiments of the present disclosure, referring to FIG. 5, the first positioning portion 304 is a groove formed by recessing the outer peripheral surface 302 of the insulating spacer 30 to the inside of the insulating spacer 30. The second positioning portion 102 is a protrusion formed on the inner surface 101 of the housing 10, and the protrusion is embedded or disposed into the groove to fix the insulating spacer 30 to the housing 10.

Thereby, by forming the groove on the insulating spacer 30 and forming the protrusion on the housing 10, the insulating spacer 30 and the housing 10 are fixed and positioned relative to each other through the engagement between the protrusion on the housing 10 and the groove on the insulating spacer 30, which can further prevent the electrode core assemblies 20 from moving and also save the space occupied by the battery 100.

As shown in FIG. 5, the insulating spacer 30 may be connected to a surface of the housing 10 with the largest area (which may also be referred to as “large surface”). Specifically, a thickness of the battery 100 extends along a second direction W. The second direction W is perpendicular to the first direction L. The housing 10 of each battery 100 includes a first side surface 11 and a second side surface 12 on two opposite sides of the second direction W, and the first side surface 11 and the second side surface 12 are the largest surfaces of the battery 100. The first side surface 11 and the second side surface 12 of the housing 10 are respectively provided with the second positioning portions 102. An inner circumferential surface of the insulating spacer 30 corresponding to the first side surface 11 and the second side surface 12 is provided with the first positioning portion 304. The first positioning portion 304 and the second positioning portion 102 are in one-to-one correspondence to be coupled to each other, so that the insulating spacer 30 is fixed to the housing 10.

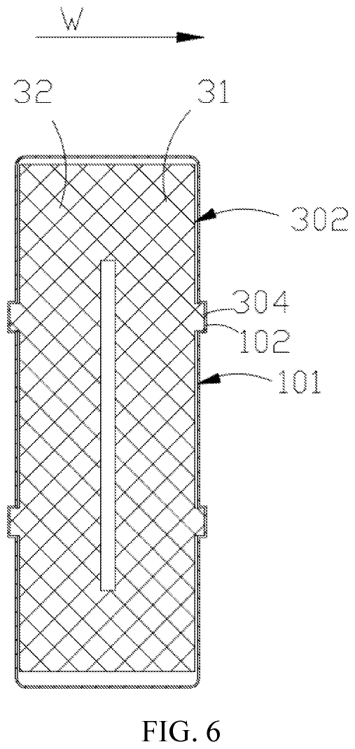

In some other embodiments of the present disclosure, referring to FIG. 6, the first positioning portion 304 may also be a protrusion formed on the outer peripheral surface 302 of the insulating spacer 30, the second positioning portion 102 may be a groove formed on the inner surface 101 of the housing 10, and the protrusion is embedded into the groove to fix the insulating spacer 30 to the housing 10.

Thereby, by forming the protrusion on the insulating spacer 30 and forming the groove on the inner surface 101 of the housing 10, the insulating spacer 30 and the housing 10 are fixed and positioned relative to each other through the mating between the groove on the housing 10 and the protrusion on the insulating spacer 30, which can further prevent the electrode core assemblies 20 from moving and also save the space occupied by the battery 100.

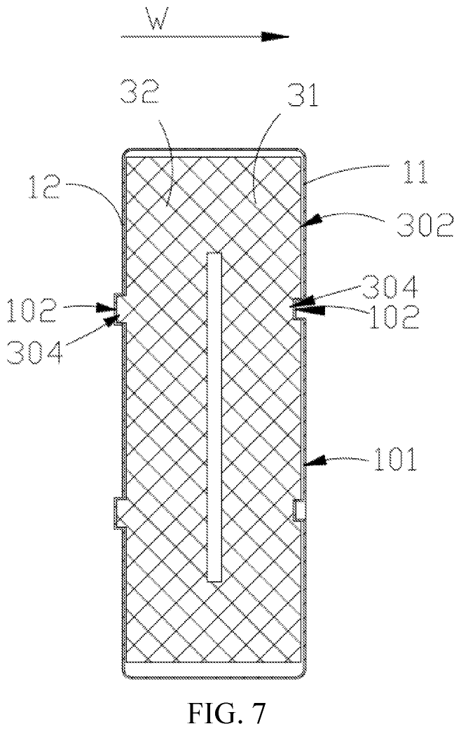

In still other embodiments of the present disclosure, referring to FIG. 7, the second positioning portion 102 on the first side surface 11 is a protrusion formed on the inner surface 101 of the housing 10, the first positioning portion 304 is a groove formed on the outer peripheral surface 302 of the insulating spacer 30 corresponding to the protrusion, and the protrusion is coupled with the groove. The second positioning portion 102 on the second side surface 12 is a groove formed on the inner surface 101 of the housing 10, the first positioning portion 304 is a protrusion formed on the outer peripheral surface 302 of the insulating spacer 30 corresponding to the groove, and the protrusion is coupled with the groove.

Thereby, on the housing 10 of the battery 100, the second positioning portion 102 on the first side surface 11 is the protrusion, and the corresponding first positioning portion 304 is the groove. The second positioning portion 102 on the second side surface 12 is the groove, and the corresponding first positioning portion 304 is the protrusion. The protrusion is coupled with the groove, so that the insulating spacer 30 and the housing 10 are fixed and positioned relative to each other, and the housing 10 and the housing 10 are also fixed and positioned relative to each other, which can further prevent the electrode core assemblies 20 from moving and also prevent the relative movement between the housings 10 of adjacent batteries 100.

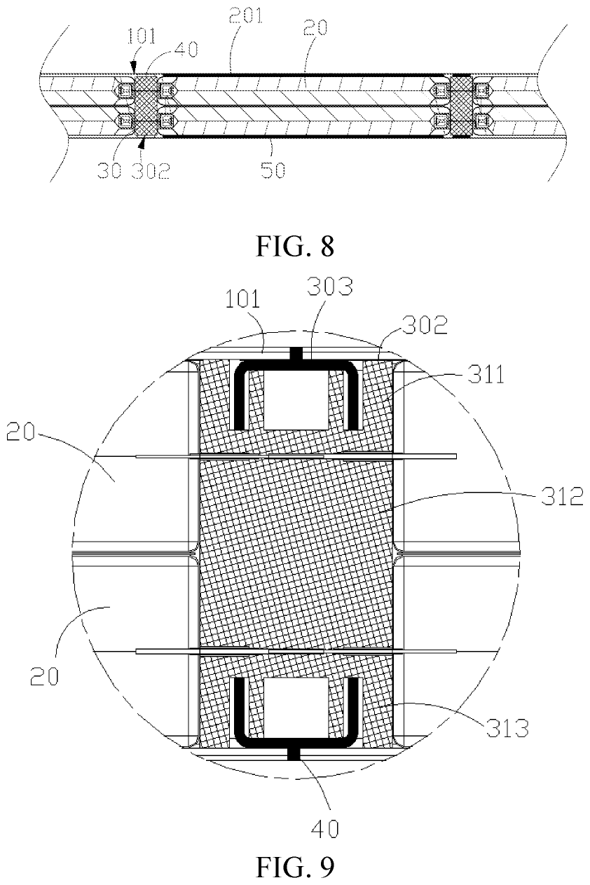

Referring to FIG. 8, in a second embodiment of the present disclosure, the insulating spacer 30 includes an outer peripheral surface 302 facing an inner surface of the housing 10. The housing 10 includes the inner surface 101 facing the insulating spacer 30. A first adhesive layer 40 is arranged between the outer peripheral surface 302 of the insulating spacer 30 and the inner surface of the housing 10 to fix the insulating spacer 30 to the housing 10.

Thereby, by arranging the first adhesive layer 40 between the outer peripheral surface 302 of the insulating spacer 30 and the inner surface of the housing 10, the insulating spacer 30 is fixed to the housing 10, which can further prevent the relative movement between the electrode core assemblies 20, thereby improving the effect of preventing movement.

In some embodiments of the present disclosure, the first adhesive layer 40 is a heat-sensitive adhesive. After the electrode core assembly 20 is mounted into the housing 10, the first adhesive layer 40 is heated by a preset temperature to become sticky, to fix the insulating spacer 30 to the housing 10. It should be noted that the first adhesive layer 40 is not sticky before the electrode core assembly 20 is mounted into the housing 10. After the electrode core assembly 20 is mounted into the housing 10, the first adhesive layer 40 is heated to become sticky, so that the insulating spacer 30 is fixed to the housing 10. In this way, the insulating spacer 30 can be fixed to the housing 10, and the mounting is convenient.

In some other embodiments of the present disclosure, the first adhesive layer 40 is a pressure-sensitive adhesive. The first adhesive layer 40 is not sticky before the electrode core assembly 20 is mounted into the housing 10. After the electrode core assembly 20 is mounted into the housing 10, the first adhesive layer 40 is compressed by a preset pressure to become sticky, so that the insulating spacer 30 is fixed to the housing 10. In this way, the insulating spacer 30 can be fixed to the housing 10, and the mounting is convenient.

In other embodiments, the first adhesive layer 40 may also be another type of adhesive, such as a double-faced adhesive tape, which is not limited here.

It can be understood that the first adhesive layer 40 may be arranged on all of the outer peripheral surface 302 of the insulating spacer 30, or on parts of the outer peripheral surface 302 of the insulating spacer 30, which is not limited here.

In some embodiments of the present disclosure, a second adhesive layer 50 is arranged between an outer surface of the electrode core assembly 20 and the inner surface 101 of the housing 10 to fix the electrode core assembly 20 to the housing 10.

Thereby, the electrode core assembly 20 is fixed to the housing 10 through the second adhesive layer 50, so that the electrode core assembly 20 is fixed more stably, which can further prevent the relative movement between the electrode core assemblies 20.

In some embodiments of the present disclosure, the second adhesive layer 50 is a heat-sensitive adhesive or a pressure-sensitive adhesive.

In some embodiments of the present disclosure, the second adhesive layer 50 is a heat-sensitive adhesive. After the electrode core assembly 20 is mounted into the housing 10, the second adhesive layer 50 is heated by a preset temperature to become sticky, to fix the electrode core assembly 20 to the housing 10. It should be noted that the second adhesive layer 50 is not sticky before the electrode core assembly 20 is mounted into the housing 10. After the electrode core assembly 20 is mounted into the housing 10, the second adhesive layer 50 is heated to become sticky, so that the electrode core assembly 20 is fixed to the housing 10. In this way, the electrode core assembly 20 can be fixed to the housing 10, and the mounting is convenient.

In some other embodiments of the present disclosure, the second adhesive layer 50 is a pressure-sensitive adhesive. The second adhesive layer 50 is not sticky before the electrode core assembly 20 is mounted into the housing 10. After the electrode core assembly 20 is mounted into the housing 10, the second adhesive layer 50 is compressed by a preset pressure to become sticky, so that the electrode core assembly 20 is fixed to the housing 10. In this way, the electrode core assembly 20 can be fixed to the housing 10, and the mounting is convenient.

In other embodiments, the second adhesive layer 50 may also be another type of adhesive, such as a double-faced adhesive tape, which is not limited here.

It can be understood that in one of the embodiments, the second adhesive layer 50 is arranged on a large surface among the outer surfaces of the encapsulation film 201 of the electrode core assembly 20. The large surface refers to one or two outer surfaces among the outer surfaces of the encapsulation film 201 of the electrode core assembly 20 with a larger area. In other embodiments, the second adhesive layer 50 may be arranged on any one of the outer surfaces of the encapsulation film 201 of the electrode core assembly 20, which is not limited here.

In a third embodiment of the present disclosure, referring to FIG. 9, the housing 10 is a metal housing. The insulating spacer 30 includes an outer peripheral surface 302 facing an inner surface 101 of the housing 10. The outer peripheral surface 302 of the insulating spacer 30 is provided with a metal member 303. The metal member 303 is connected to the housing 10 to fix the insulating spacer 30 to the housing 10.

Thereby, in the present disclosure, the insulating spacer 30 includes the outer peripheral surface 302 facing the inner surface 101 of the housing 10. The outer peripheral surface 302 of the insulating spacer 30 is provided with the metal member 303. The metal member 303 is connected to the housing 10 to fix the insulating spacer 30 to the housing 10, which can further prevent the relative movement between the electrode core assemblies 20, thereby improving the effect of preventing movement.

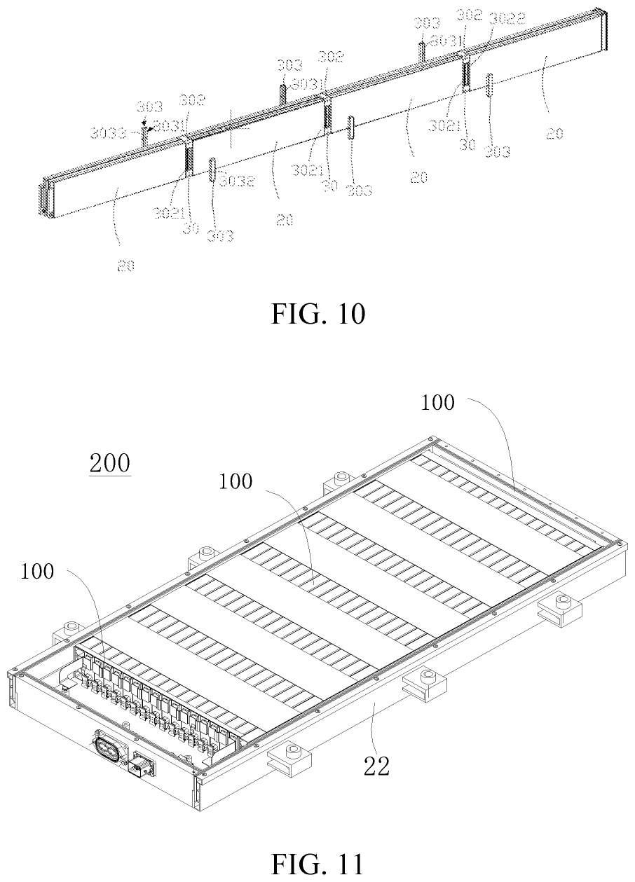

In some embodiments of the present disclosure, referring to FIG. 10, in order to fix the metal member 303 to the insulating spacer 30, the outer peripheral surface 302 of the insulating spacer 30 is provided with a snap-fit groove 3021. The metal member 303 includes a mating portion 3031 and a connecting portion 3032 connected to the mating portion 3031. The mating portion 3031 is snapped into the snap-fit groove 3021. The connecting portion 3032 is exposed on the outer peripheral surface 302 to be connected to the housing 10.

Thereby, with the snap fit between the snap-fit groove 3021 and the mating portion 3031, the connection stability between the insulating spacer 30 and the metal member 303 is improved.

In some embodiments of the present disclosure, the mating portion 3031 is multiple mating pieces 3033 vertically protruding from a periphery of the connecting portion 3032, and there is a clearance between the mating pieces 3033. For example, in this embodiment, there are 6 mating pieces 3033, and there is a clearance between every two mating pieces 3033. Similarly, a clamping slot 3022 corresponding to each of the mating pieces 3033 is arranged inside the snap-fit groove 3021. For example, in this embodiment, 6 clamping slots 3022 may be arranged inside the snap-fit groove 3021, and the six clamping slots 3022 are attached to side walls of the snap-fit groove 3021. Each mating piece 3033 is correspondingly inserted into one clamping slot 3022.

Thereby, the mating pieces 3033 make the mating portion 3031 have a good interchangeability, and thus can be coupled with the corresponding clamping slots 3022 more easily.

In some embodiments of the present disclosure, the metal member 303 has a groove structure, and a shape of the snap-fit groove 3021 is matched with that of an opening of the groove structure. A side wall of the groove structure is snapped into the snap-fit groove 3021 as the mating portion 3031, and a bottom wall of the groove of the groove structure is connected to the housing 10 as the connecting portion 3032.

Thereby, the metal member 303 occupies less space, which makes the overall structure of the battery 100 more compact.

In some embodiments of the present disclosure, the snap-fit groove 3021 and the mating portion 3031 form an interference fit to be fixed to each other.

Thereby, with the snap fit between the snap-fit groove 3021 and the mating portion 3031, the connection stability between the insulating spacer 30 and the metal member 303 is improved.

In some embodiments of the present disclosure, the metal member 303 is integrally formed with the insulating spacer 30 by insert molding, and the metal member is made of an aluminum material.

Thereby, the process of mounting the metal member 303 is avoided, and the connection stability between the metal member 303 and the insulating spacer 30 is improved.

In some embodiments of the present disclosure, the metal member 303 is fixed to the housing 10 by welding, for example, laser welding. As shown in FIG. 9, a laser welding joint 40 is formed between the metal member 303 and the housing 10.

Thereby, the connection stability between the metal member 303 and the housing 10 is improved, which can prevent the relative movement between the electrode core assemblies 20 along the first direction L, maintain the effective connection between the electrode core assemblies 20, and increase the mechanical strength of the battery 100, thereby preventing the battery 100 from being twisted or broken during the use.

Referring to FIG. 9, when the battery 100 contains two electrode core strings, i.e., when on each side of the insulating spacer 30 along the first direction L, two electrode core assemblies 20 are arranged. The insulating spacer 30 includes a first insulating part 311, a second insulating part 312 and a third insulating part 313 that are arranged sequentially along the second direction W. The second insulating part 312 is arranged between the first insulating part 311 and the third insulating part 313. Outer sides of the first insulating part 311 and the third insulating part 313 are respectively provided with the snap-fit groove 3021. A through hole 301 is formed between the first insulating part 311 and the second insulating part 312 for allowing the connection part of one of the electrode core strings to pass through. Another through hole (not shown) is formed between the second insulating part 312 and the third insulating part 313 for allowing the connection part of the other electrode core string to pass through.

In some embodiments of the present disclosure, the battery 100 is substantially a cuboid. The battery 100 has a length L, a thickness W and a height H. The length L is greater than the height H. The height H is greater than the thickness W. The length of the battery 100 is 400-2500 mm. A ratio of the length to the height of the battery 100 is 4-21.

It should be noted that “the battery 100 is substantially a cuboid” can be understood as “the battery 100 may be a cuboid or cube, or roughly a cuboid or cube but irregularly shaped in part, or approximately a cuboid or cube that has notches, protrusions, chamfers, arcs and bends in part.

The present disclosure further provides a battery pack, including multiple batteries 100 provided by the present disclosure or multiple battery modules provided by the present disclosure. Referring to FIG. 11, the battery pack 200 provided by the present disclosure includes a tray 22 and the batteries 100 arranged on the tray 22.

The present disclosure provides an automobile 1000, including a battery pack 200 provided by the present disclosure.

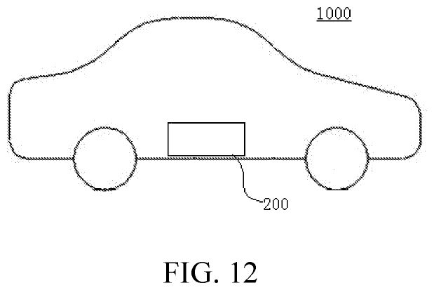

Referring to FIG. 12, the automobile provided by the present disclosure includes the battery pack 200.

Although the embodiments of the present disclosure have been shown and described, persons of ordinary skill in the art should understand that various changes, modifications, replacements and variations may be made to the embodiments without departing from the principles and spirit of the present disclosure, and the scope of the present disclosure is as defined by the appended claims and their equivalents.

What is claimed is:

1. A battery, comprising a housing and a plurality of electrode core assemblies disposed in the housing, wherein
two adjacent electrode core assemblies of the plurality of electrode core assemblies are connected in series, each of the electrode core assemblies comprises an encapsulation film and at least one electrode core, and the at least one electrode core is disposed in an accommodating cavity formed by the encapsulation film; and
each of the electrode core assemblies comprises a first electrode and a second electrode for leading out a current, the first electrode and the second electrode protrude out of the encapsulation film, a first electrode of a first electrode core assembly of the two adjacent electrode core assemblies is connected to a second electrode of the a second electrode core assembly of the two adjacent electrode core assemblies, a gap between the two adjacent electrode core assemblies is filled with an insulating material to form an insulating spacer between the two adjacent electrode core assemblies, and a connection part of the two adjacent electrode core assemblies is arranged in the insulating spacer.

2. The battery according to claim 1, wherein the insulating spacer comprises an outer peripheral surface facing an inner surface of the housing, a first positioning portion is formed on the outer peripheral surface of the insulating spacer, a second positioning portion is formed on the inner surface of the housing, and the first positioning portion is coupled with the second positioning portion to fix the insulating spacer to the housing.

3. The battery according to claim 2, wherein
the first positioning portion includes a groove recessed on the outer peripheral surface of the insulating spacer, the second positioning portion includes a protrusion formed on the inner surface of the housing, and the protrusion of the second positioning portion is disposed into the groove of the first positioning portion; or
the first positioning portion includes a protrusion formed on the outer peripheral surface of the insulating spacer, the second positioning portion includes a groove formed on the inner surface of the housing, and the protrusion of the first positioning portion is disposed into the groove of the second positioning portion.

4. The battery according to claim 1, wherein
the insulating spacer comprises an outer peripheral surface facing an inner surface of the housing, a first adhesive layer is arranged between the outer peripheral surface of the insulating spacer and the inner surface of the housing to fix the insulating spacer to the housing, and the first adhesive layer is a heat-sensitive adhesive or a pressure-sensitive adhesive; and/or
a second adhesive layer is arranged between an outer surface of the first electrode core assembly and the inner surface of the housing to fix the first electrode core assembly to the housing, and the second adhesive layer is a heat-sensitive adhesive or a pressure-sensitive adhesive.

5. The battery according to claim 1, wherein the insulating spacer comprises an outer peripheral surface facing an inner surface of the housing, the outer peripheral surface of the insulating spacer has a metal member, and the metal member is connected to the housing to fix the insulating spacer to the housing.

6. The battery according to claim 5, wherein
the outer peripheral surface of the insulating spacer has a snap-fit groove, the metal member comprises a mating portion and a connecting portion connected to the mating portion, the mating portion is snapped into the snap-fit groove, and the connecting portion is exposed on the outer peripheral surface to be connected to the housing;
the metal member has an opening, a side wall, and a bottom wall, and a shape of the snap-fit groove is matched with a shape of the opening of the metal member, and the side wall of the metal member is snapped into the snap-fit groove as the mating portion, and the bottom wall of the metal member is connected to the housing as the connecting portion.

7. The battery according to claim 5, wherein the metal member is integrally formed with the insulating spacer, the metal member is made of aluminum, and the metal member is fixed to the housing by welding.

8. The battery according to claim 1, wherein a length of the battery extends along a first direction, a length of each of the plurality of electrode core assemblies extends along the first direction, and the plurality of electrode core assemblies are arranged along the first direction.

9. A battery pack, comprising a plurality of batteries, wherein each of the plurality of batteries comprises a housing and a plurality of electrode core assemblies disposed in the housing, and wherein
two adjacent electrode core assemblies of the plurality of electrode core assemblies are connected in series, each of the electrode core assemblies comprises an encapsulation film and at least one electrode core, and the at least one electrode core is disposed in an accommodating cavity formed by the encapsulation film; and
each of the electrode core assemblies comprises a first electrode and a second electrode for leading out a current, the first electrode and the second electrode protrude out of the encapsulation film, a first electrode of a first electrode core assembly of the two adjacent electrode core assemblies is connected to a second electrode of the a second electrode core assembly of the two adjacent electrode core assemblies, a gap between the two adjacent electrode core assemblies is filled with an insulating material to form an insulating spacer between the two adjacent electrode core assemblies, and a connection part of the two adjacent electrode core assemblies is arranged in the insulating spacer.

10. The battery pack according to claim 9, wherein the insulating spacer comprises an outer peripheral surface facing an inner surface of the housing, a first positioning portion is formed on the outer peripheral surface of the insulating spacer, a second positioning portion is formed on the inner surface of the housing, and the first positioning portion is coupled with the second positioning portion to fix the insulating spacer to the housing.

11. The battery pack according to claim 10, wherein
the first positioning portion includes a groove recessed on the outer peripheral surface of the insulating spacer, the second positioning portion includes a protrusion formed on the inner surface of the housing, and the protrusion of the second positioning portion is disposed into the groove of the first positioning portion; or
the first positioning portion includes a protrusion formed on the outer peripheral surface of the insulating spacer, the second positioning portion includes a groove formed on the inner surface of the housing, and the protrusion of the first positioning portion is disposed into the groove of the second positioning portion.

12. The battery pack according to claim 9, wherein
the insulating spacer comprises an outer peripheral surface facing an inner surface of the housing, a first adhesive layer is arranged between the outer peripheral surface of the insulating spacer and the inner surface of the housing to fix the insulating spacer to the housing, and the first adhesive layer is a heat-sensitive adhesive or a pressure-sensitive adhesive; and/or
a second adhesive layer is arranged between an outer surface of the first electrode core assembly and the inner surface of the housing to fix the first electrode core assembly to the housing, and the second adhesive layer is a heat-sensitive adhesive or a pressure-sensitive adhesive.

13. The battery pack according to claim 9, wherein the insulating spacer comprises an outer peripheral surface facing an inner surface of the housing, the outer peripheral surface of the insulating spacer has a metal member, and the metal member is connected to the housing to fix the insulating spacer to the housing.

14. The battery pack according to claim 13, wherein
the outer peripheral surface of the insulating spacer has a snap-fit groove, the metal member comprises a mating portion and a connecting portion connected to the mating portion, the mating portion is snapped into the snap-fit groove, and the connecting portion is exposed on the outer peripheral surface to be connected to the housing;
the metal member has an opening, a side wall, and a bottom wall, and a shape of the snap-fit groove is matched with a shape of the opening of the metal member, and the side wall of the metal member is snapped into the snap-fit groove as the mating portion, and the bottom wall of the metal member is connected to the housing as the connecting portion.

15. The battery pack according to claim 13, wherein the metal member is integrally formed with the insulating spacer, the metal member is made of aluminum, and the metal member is fixed to the housing by welding.

16. The battery pack according to claim 9, wherein a length of the battery extends along a first direction, a length of each of the plurality of electrode core assemblies extends along the first direction, and the plurality of electrode core assemblies are arranged along the first direction.

17. An automobile, comprising a battery pack comprising a plurality of batteries, wherein each of the plurality of batteries comprises a housing and a plurality of electrode core assemblies disposed in the housing, and wherein
two adjacent electrode core assemblies of the plurality of electrode core assemblies are connected in series, each of the electrode core assemblies comprises an encapsulation film and at least one electrode core, and the at least one electrode core is disposed in an accommodating cavity formed by the encapsulation film; and
each of the electrode core assemblies comprises a first electrode and a second electrode for leading out a current, the first electrode and the second electrode protrude out of the encapsulation film, a first electrode of a first electrode core assembly of the two adjacent electrode core assemblies is connected to a second electrode of the a second electrode core assembly of the two adjacent electrode core assemblies, a gap between the two adjacent electrode core assemblies is filled with an insulating material to form an insulating spacer between the two adjacent electrode core assemblies, and a connection part of the two adjacent electrode core assemblies is arranged in the insulating spacer.

18. The automobile according to claim 17, wherein the insulating spacer comprises an outer peripheral surface facing an inner surface of the housing, a first positioning portion is formed on the outer peripheral surface of the insulating spacer, a second positioning portion is formed on the inner surface of the housing, and the first positioning portion is coupled with the second positioning portion to fix the insulating spacer to the housing.

19. The automobile according to claim 18, wherein
the first positioning portion includes a groove recessed on the outer peripheral surface of the insulating spacer, the second positioning portion includes a protrusion formed on the inner surface of the housing, and the protrusion of the second positioning portion is disposed into the groove of the first positioning portion; or
the first positioning portion includes a protrusion formed on the outer peripheral surface of the insulating spacer, the second positioning portion includes a groove formed on the inner surface of the housing, and the protrusion of the first positioning portion is disposed into the groove of the second positioning portion.

20. The automobile according to claim 17, wherein
the insulating spacer comprises an outer peripheral surface facing an inner surface of the housing, a first adhesive layer is arranged between the outer peripheral surface of the insulating spacer and the inner surface of the housing to fix the insulating spacer to the housing, and the first adhesive layer is a heat-sensitive adhesive or a pressure-sensitive adhesive; and/or
a second adhesive layer is arranged between an outer surface of the first electrode core assembly and the inner surface of the housing to fix the first electrode core assembly to the housing, and the second adhesive layer is a heat-sensitive adhesive or a pressure-sensitive adhesive.
